(19) United States
(12) Patent Application Publication
(10) Pub. No.: US 2002/0176376 A1
(43) Pub. Date: Nov. 28, 2002

(54) Method of and system for remotely invoking processing tasks at a task processor through voice commands from a terminal device

(76) Inventor: Jeffrey S. Bertino, Poway, CA (US)

Correspondence Address: Qualcomm Incorporated, Patents Department, 5775 Morehouse Drive, San Diego, CA, 92121-1714, US

(21) Appl. No.: 09/818,333

(22) Filed: Mar. 26, 2001

(51) Int. Cl. H04B 7/216

(52) U.S. Cl. 370/278; 370/342

(57) ABSTRACT

A method and system for remotely invoking processing tasks at a task processor through voice commands from a terminal device across a data connection. A voice command session is initiated with the task processor across the data connection. The terminal device then receives an acknowledgment from the task processor that a session is established. After the task processor has acknowledged the session, an application specific command is sent to the task processor. The terminal device then receives a response to the application specific command. The steps of sending a command and receiving a response can be repeated by a user, as desired.

### BACKGROUND OF THE INVENTION

1. Field of the Invention

The present invention relates generally to communications systems. More particularly, the present invention relates to a method of and system for remotely invoking processing tasks at a task processor through voice commands from a terminal device.

2. Related Art

Businesses and organizations are becoming increasingly dependent on processing platforms to perform calculations and to provide access to information such as email, computer files, spreadsheets, and database records.

The advent of portable communications devices such as portable phones, personal digital assistants (PDAs), and pagers enable people to remotely access information and initiate processing tasks from virtually any place in the world. Despite this increased accessibility to information and processing, in many circumstances, these portable communications devices do not afford users with interfaces that enable the convenient access and retrieval of information from remote processing platforms.

Professionals often desire the ability to remotely access information while they are simultaneously performing other tasks. For example, real estate agents, delivery persons, and truck drivers often need to obtain information such as street addresses, email, and inventory information while operating vehicles.

Unfortunately, portable communications devices typically have user interfaces that provide for the access of information through displays, keypads, and/or touch screens. These interfaces can be inconvenient because they monopolize a user's attention. Thus, when performing tasks, such as driving or operating machinery, users encounter difficulties in trying to simultaneously focus their attention on device operation and the task at hand. Such difficulties can lead to dangerous results, such as automobile accidents and personal injury.

Current speech processing technology enables information to be converted from text to speech and from speech to text. This technology permits the development of interfaces that do not distract users away from other tasks. Accordingly, what is needed is a method and system for remotely invoking processing tasks through voice commands.

### SUMMARY OF THE INVENTION

The present invention provides a method and system for remotely invoking processing tasks at a task processor through voice commands from a terminal device across a data connection. In an embodiment, the terminal device is a portable handset, such as a wireless telephone, or a PDA, and the data connection includes a wireless Code Division Multiple Access (CDMA) link.

According to the present invention, a voice command session is initiated with the task processor across the data connection. The terminal device then receives an acknowledgment from the task processor that a session is established. After the task processor has acknowledged the session, an application specific command is sent to the task processor. The terminal device then receives a response to the application specific command. The steps of sending a command and receiving a response can be repeated by a user, as desired.

The step of sending an application specific command may include the steps of a user activating a push to talk (PTT) button on the terminal device, and speaking a voice command into a microphone on the terminal device while the PTT button is activated.

An advantage of the present invention is the ability to provide a user with the capability to remotely invoke processing tasks and/or receive information without monopolizing the user's attention.

### BRIEF DESCRIPTION OF THE DRAWINGS

The present invention will be described with reference to the accompanying drawings. In the drawings, like reference numbers generally indicate identical, functionally similar, and/or structurally similar elements. The drawing in which an element first appears is indicated by the leftmost digit(s) in the reference number.

FIG. 1 is an illustration of an exemplary communications system, according to an embodiment of the present invention;

FIGS. 2A and 2B are block diagrams of first and second implementations of a communications system;

FIG. 3 is a block diagram of a terminal device;

FIG. 4 is a block diagram of a task processor;

FIG. 5 is a flowchart illustrating interaction between a terminal device and a task processor; and

FIGS. 6 and 7 are state diagrams of a terminal device and a task processor.

### DETAILED DESCRIPTION OF THE PREFERRED EMBODIMENTS

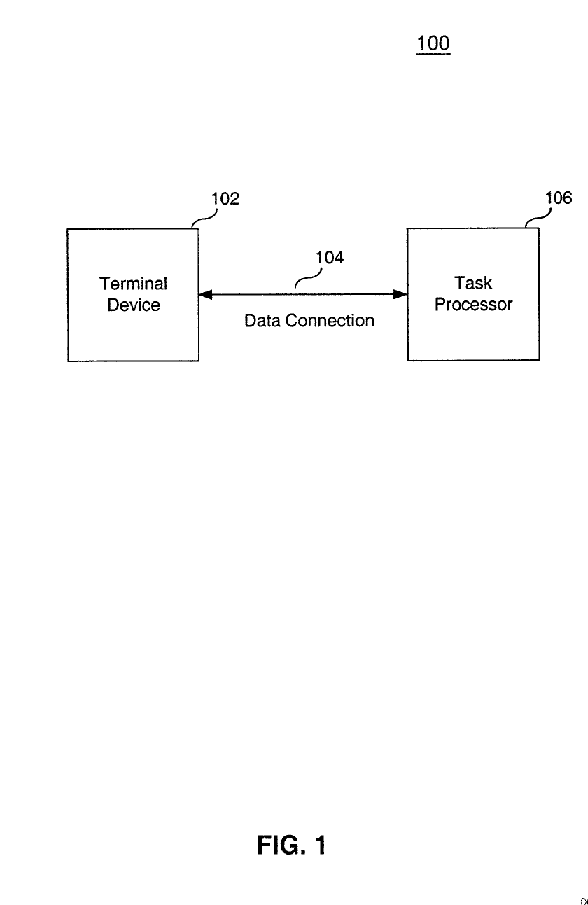

FIG. 1 is an illustration of an exemplary communications system 100. Communications system 100 includes a terminal device 102, a data connection 104, and a task processor 106.

Terminal device 102 communicates with task processor 106 across data connection 104. Terminal device 102 transmits requests (also referred to herein as commands) for processing tasks to be performed by task processor 106. These requests are input by a user through a user interface (not shown) on terminal device 102. These requests can be in the form of voice commands. Terminal device 102 also receives information originated by task processor 106. Terminal device 102 can output this information to a user through the user interface.

Terminal device 102 may be a portable communications device (also referred to herein as a portable handset). Examples of portable communications devices include cellular and satellite phones. Further examples of portable communications devices include personal computers, pagers, PDAs, and wireless personal computers.

Task processor 106 processes tasks in response to requests generated by terminal device 102. These tasks involve the generation and/or the retrieval of information. This information can then be transmitted to terminal device 102 across data connection 104.

Data connection 104 enables the bidirectional exchange of information between terminal device 102 and task processor 106. Data connection 104 can be a circuit-switched connection, a packet-switched connection, or any other type of connection that is apparent to persons skilled in the relevant art(s). Data connection 104 can include one or more communications links. For instance, data connection 104 can be implemented with any combination of wireless communications links, wireline communications links, and/or data networks.

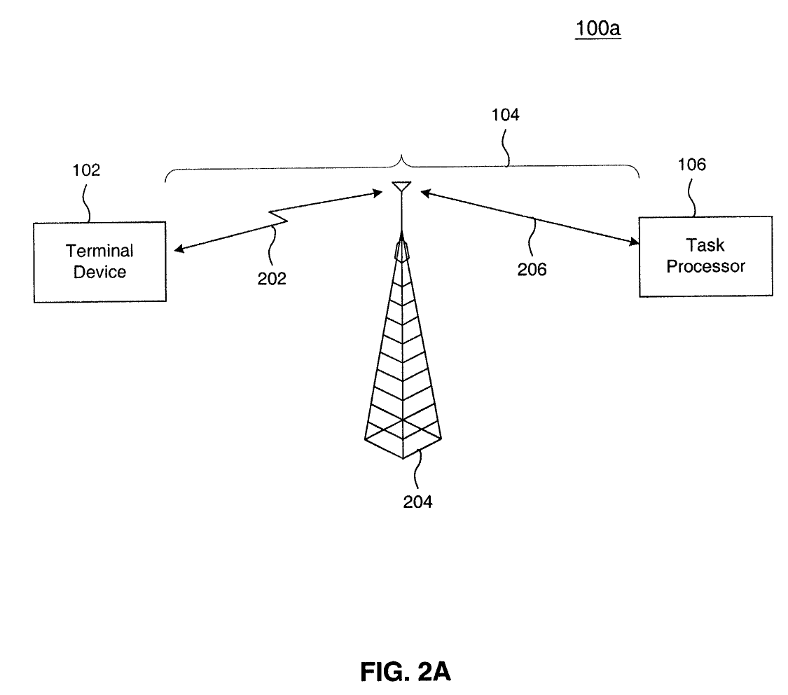

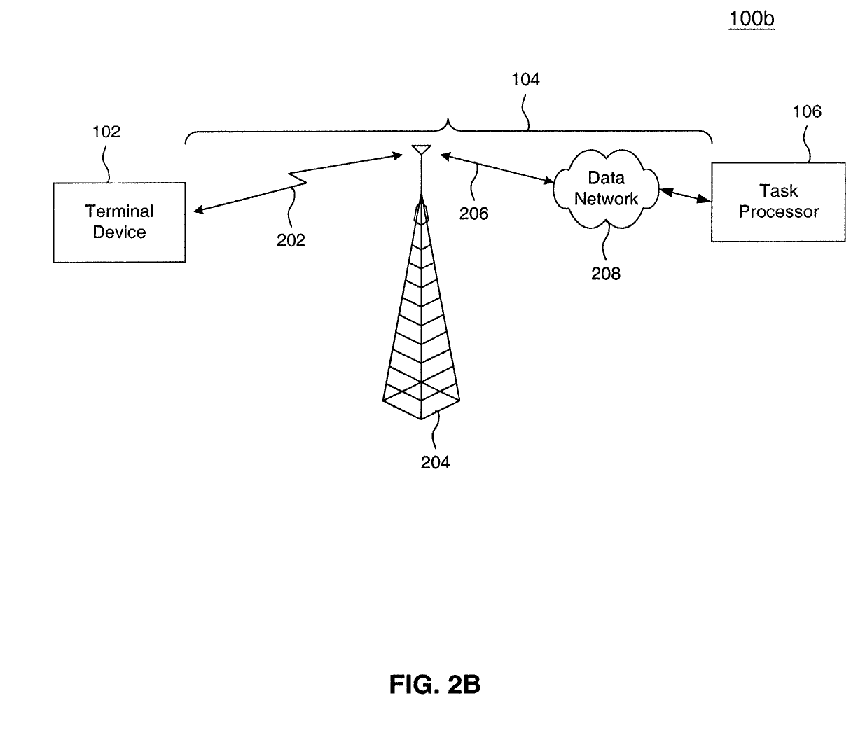

FIGS. 2A and 2B are block diagrams of first and second implementations 100a and 100b of communications system 100. Implementations 100a and 100b differ according to their respective data connections 104. These implementations are presented by way of example only. Other communications topologies and architectures may be employed, as would be apparent to persons skilled in the relevant art(s).

FIG. 2A is a block diagram of implementation 100a, where data connection 104 includes a wireless link 202, a network access point 204, and a wireline link 206. Wireless link 202 enables the exchange of information between terminal device 102 and network access point 204. Wireline link 206 enables the exchange of information between network access point 204 and task processor 106.

Wireless link 202 may be a CDMA data link, as specified under IS-707. IS-707 enables bidirectional asynchronous circuit-switched and bidirectional packet data communications across a radio frequency (RF) medium. IS-707 communications are well known and described in the document entitled “Data Service Options for Wideband Spread Spectrum Communications Systems,” Document Number TIA/EIA/IS-707A, published Apr. 25, 1999 by the Telecommunications Industry Association (TIA) (incorporated herein by reference in its entirety). Instead of being an IS-707 link, wireless link 202 may be other types of packet-switched or circuit-switched communications links. For example, wireless link 202 may be a wireless Internet Protocol (IP) packet-switched communications link, a cellular circuit-switched communications link, or any other type of communications links that would be apparent to persons skilled in the relevant art(s).

Network access point 204 provides an interface between wireless link 202 and wireline link 206. Network access point 204 may be a termination point for portable wireless communications devices, such as a base station or a satellite. Network access point 204 converts information transferred across data connection 104 between formats and/or protocols supported by wireless link 202, and formats and/or protocols supported by wireline link 206.

As described above, wireline link 206 enables the exchange of information between network access point 204 and task processor 106. Wireline link 206 may be a telephony circuit that provides for bidirectional information exchange. Examples of such circuits include local loop data connections, ISDN connections, fiber optic connections.

FIG. 2B is a block diagram of implementation 100b. Like implementation 100a, data connection 104 of implementation 100b includes a wireless link 202, a network access point 204, and a wireline link 206. However, data connection 104 of implementation 100b further includes a data network 208 that connects task processor 106 to wireline link 206. Data network 208 may be an IP packet-switched network, such as the global Internet or an intranet. However, data network 208 can be other types of packet-switched networks, such as an asynchronous transfer mode (ATM) network, an X.25 network, a wireless packet-switched network, or any other network which would be apparent to persons skilled in the relevant art(s) from the teachings herein.

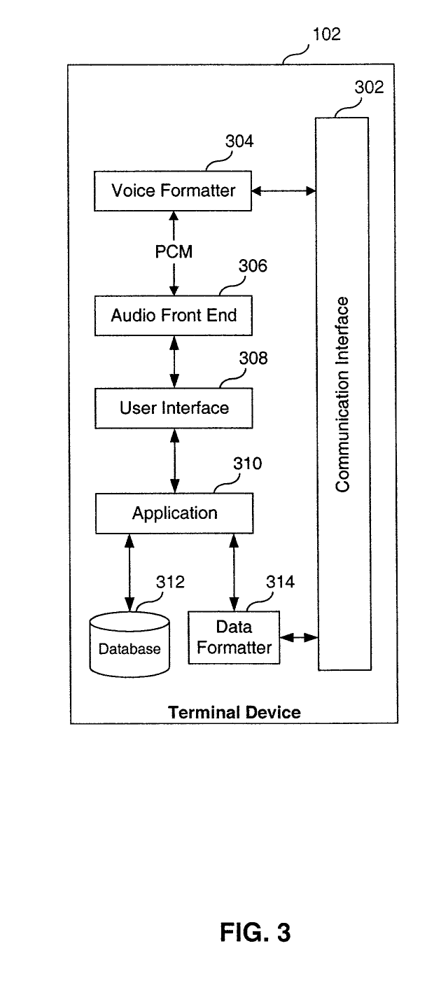

FIG. 3 is a block diagram of terminal device 102. Terminal device 102 includes a communications interface 302, a voice formatter 304, an audio front end 306, a user interface 308, an application 310, a database 312, and a data formatter 314. Terminal device 102 engages in end-to-end communications with one or more task processors 106. This end-to-end communication includes the transmission of processing requests by terminal device 102 and the transmission of responses to these tasks by task processors 106.

Communications interface 302 enables terminal device 102 to communicate with one or more task processors 106 across corresponding data connections 104. For instance, with reference to implementations 100a and 100b described above, communications interface 302 enables elements of terminal device 102 to exchange information across wireless link 202. In particular, communications interface 302 allows the exchange of voice signals through voice formatter 304, and the exchange of data signals through data formatter 314.

Application 310 is one or more software applications executed by processing platform(s) resident in terminal device 102. Examples of software applications include, but are not limited to, browsing, word processing, file access, scheduling, email, and address book applications. The execution of these applications includes processing to support user input and output through user interface 308, as well as the transmission and reception of data from one or more task processors 106 through data formatter 314 and communications interface 302.

User interface 308 enables a user to interact with terminal device 102. For instance, user interface 308 affords a user the ability to issue voice commands and receive voice responses. Thus, user interface 308 includes a microphone and a speaker. In addition, user interface 308 enables a user to input data and receive information through non-voice means. Therefore, user interface 308 can include input and output components such as keyboards, keypads, touch screens, and displays.

User interface 308 is coupled to audio front end 306. Audio front end 306 exchanges voice commands and responses with user interface 308 and converts between an analog voice signal format employed by user interface 308 and a digital signal format. This digital signal format is pulse code modulation (PCM). However, other signal formats can be used, such as pulse amplitude modulation (PAM), differential pulse code modulation (DPCM), adaptive pulse code modulation (ADPCM), and other digital signal formats, as would be apparent to persons skilled in the relevant art(s).

In an embodiment, user interface 308 includes a push to talk (PTT) button. When the PTT button is activated by a user, user interface 308 sends voice signals to audio front end 306. However, when the PTT button is not activated by a user, user interface 308 does not send voice signals to audio front end 306. Thus, the PTT feature enables a user to control when voice signals are transmitted from terminal device 102 to task processor 106. This PTT feature can be implemented with a switch that breaks the passage of analog voice signals from user interface 308 to audio front end 306. However, other techniques can be used to implement this feature, as would be apparent to persons skilled in the relevant art(s). An advantage of this PTT feature is the ability to prevent the transmission of background noise and unintended voice signals across data connection 104.

Audio front end 306 is coupled to voice formatter 304. In an embodiment, voice formatter 304 converts digital voice signals between format(s) handled by audio front end 306 and format(s) that are used for transmission across data connection 104. As described above, terminal device 102 can be coupled to wireless link 202. Wireless link can be an IS-707 CDMA data link, or other forms of data links, such as wireless IP packet-switched communications links, and cellular circuit-switched connections. The conversion performed by voice formatter 304 can include the processing and buffering of information, as would be apparent to persons skilled in the relevant art(s).

Database 312 enables the storage and access of information by application 310, user interface 308, and other components of terminal device 102. Database 312 may be implemented with memory (also referred to as storage medium). Examples of memory include short term memory, long term memory, non-volatile memory, removable memory such as a floppy disk, or any other memory that can be used to store information. Memory used to implement database 312 can be dispersed among one or more hardware storage medium components. Database 312 can retain stored data, even when terminal device 102 is powered down.

Data formatter 314 is coupled to application 310. Data formatter 314 enables end-to-end communication between application 310 and task processor 106. In an embodiment, data formatter 314 converts digital data signals between format(s) handled by application 310 and format(s) that are used for transmission across data connection 104. As described above, terminal device 102 may be coupled to wireless link 202. Wireless link can be an IS-707 CDMA data link, or other forms of data links, such as wireless IP packet-switched communications links, and cellular circuit-switched communications links. This conversion that is performed by data formatter 314 can include the processing and buffering of information, as would be apparent to persons skilled in the relevant art(s).

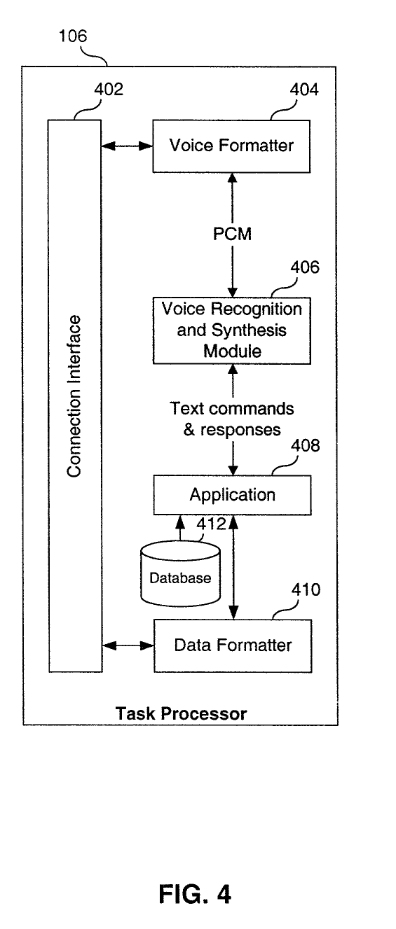

FIG. 4 is a block diagram of task processor 106. Task processor 106 includes a communications interface 402, a voice formatter 404, a voice recognition and synthesis module 406, an application 408, a data formatter 410, and a database 412. Task processor 106 engages in end-to-end communications with one or more terminal devices 102. This end-to-end communication includes the transmission of processing requests by terminal devices 102 and the transmission of responses to these task requests by task processor 106.

Communications interface 402 enables task processor 106 to communicate with one or more terminal devices 102 across corresponding data connections 104. For instance, with reference to implementations 100a and 100b described above, communications interface 402 enables elements of task processor 106 to exchange information across wireline link 206 or data network 208. In particular, communications interface 402 allows the exchange of voice signals through voice formatter 404, and the exchange of data signals through data formatter 410.

Application 408 is one or more software applications executed by processing platform(s) resident in task processor 106. Examples of such software applications include, but are not limited to, file server applications, email server applications, process server applications, database server applications, and other processing applications, as would be apparent to persons skilled in the relevant art(s). The execution of these applications includes processing to satisfy requests generated by user(s) of terminal device(s) 102. These requests are in the form of voice commands transmitted across data connection 104 as digital voice signals. Application 408 receives these requests in the form of text commands through voice recognition and synthesis module 406.

Application 408 generates and/or retrieves information to satisfy requests received from terminal device(s) 102. In addition, application 408 can transmit responses containing this information to terminal device(s) 102. These responses may be transmitted through voice formatter 404 and communications interface 402 in the form of digital voice signals. Alternatively, these responses can be transmitted through data formatter 410 and communications interface 402 in the form of data signals.

Voice formatter 404 exchanges voice signals with data connection 104 through communications interface 402. Voice formatter 404 converts digital voice signals between format(s) handled by voice recognition and synthesis module 406 and format(s) that are used for transmission across data connection 104. As described above, task processor 106 can be coupled to wireline link 206 or data network 208. The conversion performed by voice formatter 404 can include the processing and buffering of information, as would be apparent to persons skilled in the relevant art(s).

Voice recognition and synthesis module 406 exchanges voice signals with voice formatter 404. In one embodiment, the format of these voice signals is PCM. However, other signal formats can be used, such as PAM, DPCM, ADPCM, and other digital signal formats, as would be apparent to persons skilled in the relevant art(s). In addition, voice recognition and synthesis module 406 converts voice signals that are originated by terminal devices 102 and received through voice formatter 404 into text commands. These text commands are then passed to application 408 to invoke processing. Furthermore, voice recognition and synthesis module 406 converts textual responses received from application 408 into voice signals for transmission to a requesting terminal device 102. Voice recognition and synthesis module 406 performs the conversion between voice signals and text according to techniques and/or algorithms that are known to persons skilled in the relevant art(s).

Data formatter 410 is coupled to application 408. Data formatter 410 enables end-to-end communication between application 408 and terminal device 102. Data formatter 410 converts digital data signals between format(s) handled by application 408 and format(s) that are used for transmission across data connection 104. This conversion performed by data formatter 408 can include the processing and buffering of information, as would be apparent to persons skilled in the relevant art(s).

Database 412 enables the storage and access of information by application 408, and other components of task processor 104. Database 412 may be implemented with memory (also referred to as storage medium). Examples of memory include short term memory, long term memory, non-volatile memory, removable memory such as a floppy disk, or any other memory that can be used to store information. Memory used to implement database 412 can be dispersed among one or more hardware storage medium components. Database 412 can retain stored data even when task processor 106 is powered down.

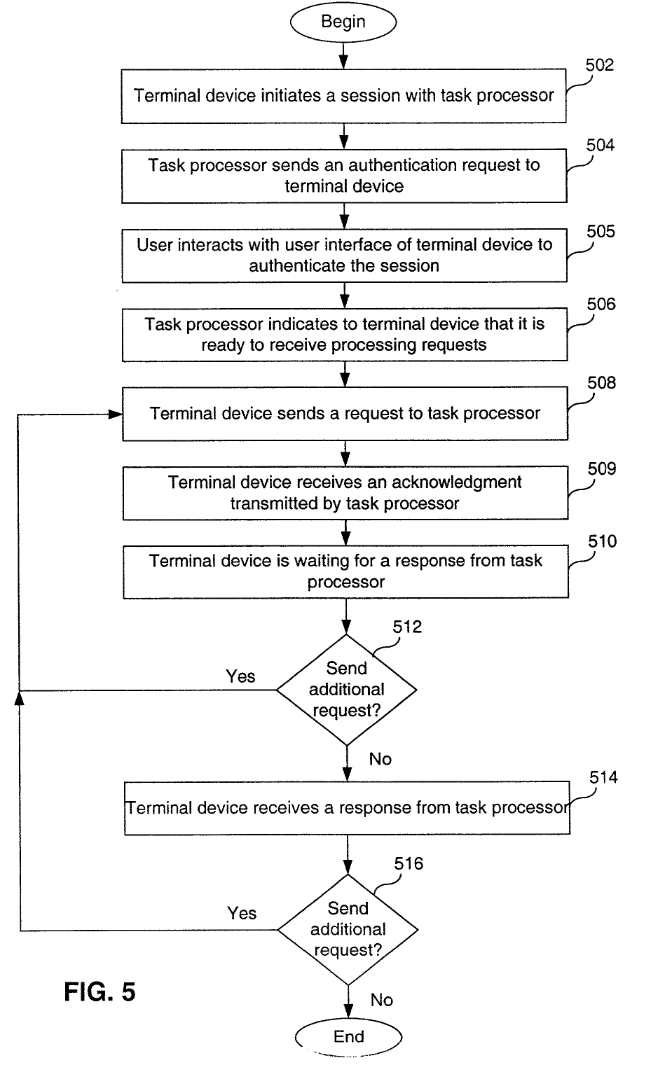

FIG. 5 is a flowchart illustrating interaction between a terminal device 102 and a task processor 106. This interaction begins with a step 502. In step 502, terminal device 102 initiates a voice command session with task processor 106. This step may comprise dialing a telephone number or an address associated with task processor 106, or sending a signaling message indicating that terminal device 102 is seeking to establish a voice command session with task processor 106.

In a step 504, task processor 106 sends an authentication request to terminal device 102. This step comprises the step of sending a request for a user to enter a password through user interface 308 of terminal device 102.

A step 505 follows step 504. In step 505, a user interacts with user interface 308 of terminal device 102 to authenticate the session. In an embodiment, this step comprises a user entering a password through a keypad.

Next, in a step 506, task processor 106 indicates to terminal device 102 that it is ready to receive processing requests. That is, terminal device 102 receives an acknowledgment from task processor 106 that a session is established. In one embodiment, this step comprises the step of sending a data signal for display to a user through user interface 308. In a further embodiment, this step comprises the step of sending a voice signal, such as “session established” for audio output through user interface 308.

A step 508 is performed after step 506. In step 508, terminal device 102 sends a request to task processor 106. This request is an application specific command. That is, it is a request for application 408 at task processor 106 to perform a specific task. This step comprises a user pressing a PTT button on user interface 308 of terminal device 102, and speaking a voice command into a microphone on user interface 308 while the PTT button is depressed. An exemplary set of voice commands is provided below in Table 1.

Next in a step 509, terminal device 102 receives an acknowledgment transmitted by task processor 106. This acknowledgment indicates that task processor 106 is processing the request or command sent by terminal device 102 in step 508. This acknowledgment can be in the form of data to be displayed on user interface 308, or a voice signal output through a speaker on user interface 308. This step enables a user to verify that the request has been received by task processor 106.

Next, in a step 510, terminal device 102 is waiting for a response from task processor 106. This step can comprise a message that is output through user interface 308, such as “request pending.” Additionally, this output can indicate the number of requests that are pending. These messages can be output either as displayed text, or audio voice signals.

A step 512 follows step 510. In step 512, a user can interact with terminal device 102 to send an additional request to task processor 106. If a user so chooses, steps 508 through 510 are performed again. Otherwise, a step 514 is performed.

In step 514, terminal device 102 receives from task processor 106 a response to an application specific command transmitted in step 508. This response can comprise data and/or voice signals. Responses in the form of data are received by application 310 through data formatter 314. Once received, this data can be displayed to a user through user interface 308, and/or stored in database 312. Responses in the form of voice signals can be received through voice formatter 304 and audio front end 306. Once received, these voice signals are output to a user through a speaker in user interface 308.

Responses received during the performance of step 514 convey information targeted at satisfying the corresponding request sent by terminal device 102 in step 508. This information can be in any format that would be apparent to persons skilled in the relevant art(s). For instance, responses can be in the form of files, documents written in hypertext markup languages, spreadsheets, database records, and email. Responses can also be in the form of calendar, appointment and scheduling information. Also, responses can be in the form of contact information such as street addresses, phone numbers, URLs, and email addresses. These responses can be transferred across data connection 104 as data signals and/or voice signals. Such data signals are received by application 310 through data formatter 314 and communications interface 302. The information contained in these data signals can be displayed by user interface 308. Such voice signals are received by user interface 308 through audio front end 306, voice formatter 304, and communications interface 302. As described above, user interface 308 includes a speaker that can output these voice signals.

Next, in a step 516, a user interacts with user interface 308 to determine whether to send an additional request. If a user so chooses, steps 508 through 514 are performed again.

Table 1 provides an exemplary set of voice commands according to the present invention. Other voice commands, can be included in the present invention, as would be apparent to persons skilled in the relevant art(s).

TABLE 1

| Voice Command | Description |
|---|---|
| “download <resource name>” | Commands task processor 106 to |
| | send a resource designated by |
| | <resource name> to terminal device |
| | 102 in the form of data. Resources |
| | can include files, email, database |
| | records, pages written in markup |
| | languages, schedules, contact lists, |
| | and other resources that would be |
| | apparent to persons skilled in the |
| | relevant art(s). Resources sent |
| | according to this command can be |
| | stored in database 312. |
| “recite <resource name>” | Commands task processor 106 to |
| | send to a resource designated by |
| | <resource name> to terminal device |
| | 102 in the form of digital voice |
| | signals. Resources can include files, |
| | email, database records, pages |
| | written in markup languages, |
| | schedules, contact lists, and other |
| | resources that would be apparent to |
| | persons skilled in the relevant art(s). |
| “dictate <user speech>” | Commands task processor 106 to |
| | record speech <user speech> uttered |
| | by a user of terminal device 102 and |
| | to convert it to text with voice |
| | recognition and synthesis module |
| | 406. This text can be stored in |
| | database 412. |

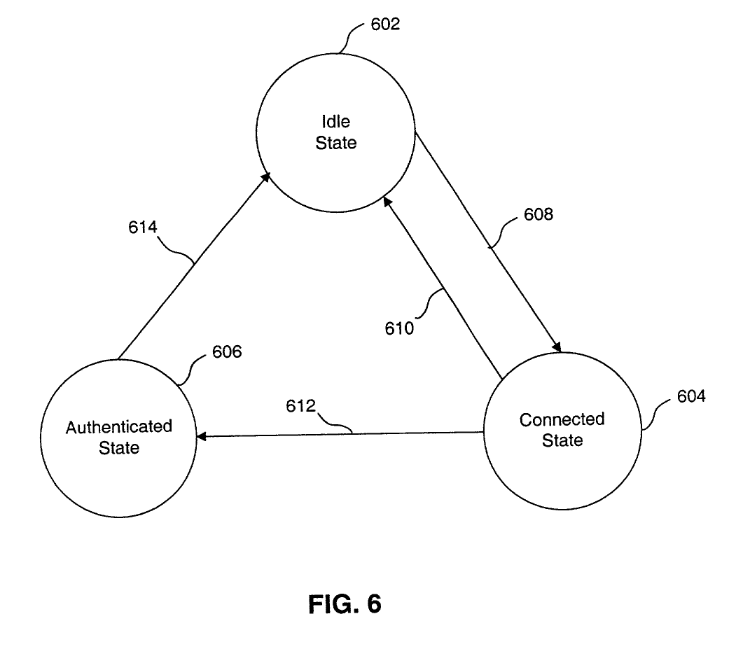

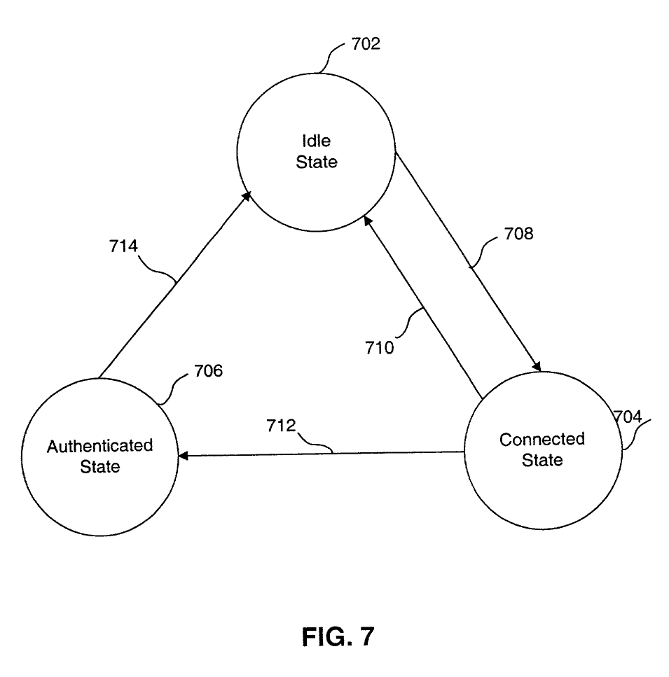

In addition to the operational sequence described above with respect to FIG. 5, performance of terminal device 102 and task processor 106 are described below with reference to state diagrams provided in FIGS. 6 and 7.

FIG. 6 is a state diagram illustrating various operational states of terminal device 102. As shown in FIG. 6, terminal device 102 may operate in an idle state 602, a connected state 604, and an authenticated state 606. Transition events 608, 610, 612, and 614 cause transitions between these states.

When terminal device 102 is operating in idle state 602, there is no connection or session established with task processor 106. Thus, voice commands are not sent to task processor 106 during this state.

Terminal device 102 operation transitions from idle state 602 to connected state 604 upon an occurrence of transition event 608. Transition event 608 occurs when a user causes a connection (or session) to be established with task processor 106. A user establishes such a connection through interaction with user interface 308 of terminal device 102. This interaction may include dialing a telephone number, or entering input commands that establish a session with a packet switched network, such as data network 208.

While terminal device 102 is operating in connected state 604, a user is allowed to send authentication information, such as a password to task processor 106. This authentication information is entered through user interface 308 by techniques, such as keyboard entry or voice command. When authentication information is entered through a voice command, a user presses a PTT button on user interface 308 while uttering the voice command. This authentication information indicates to task processor 106 that the user is authorized to send task requests to task processor 106.

Terminal device 102 operation returns to idle state 602 from connected state 604 upon the occurrence of transition event 610. Event 610 may occur in at least two ways. The first way is a failure to receive an authentication acknowledgment after a predetermined amount of time elapses from the transmission of authentication information. The second way is the reception of an authentication denial message from task processor 106.

Transition event 612 moves terminal device 102 operation from connected state 604 to authenticated state 606. This event occurs when terminal device 102 receives an authentication approval message from task processor 106. This response indicates that the user is authenticated.

Upon entry into authenticated state 606, an indication is output on user interface 308 to alert a user that he is authenticated. This indication may be output through a display. This indication may also by output through a speaker in the form of an audio voice signal declaring “session established.”

While terminal device 102 is operating in authenticated state 606, a user may send one or more voice commands to task processor 106 through the established data connection. Each of these commands are application specific. That is, each of these commands is a request for task processor 106 to perform a specific task. Sending a voice command to task processor 106 includes a user activating a PTT button on user interface 308, and speaking a voice command into a microphone on user interface 308 while the PTT button is activated.

In state 606, terminal device 102 also receives acknowledgments from task processor 106 that correspond to particular voice commands and indicate that task processor 106 has received the corresponding commands to be processed by application 408. These acknowledgments can be in the form of data to be displayed by user interface 308, or a voice signal output through a speaker on user interface 308. These acknowledgments advantageously enable a user to verify that commands have been received by task processor 106.

In addition to receiving acknowledgments while in authenticated state 606, terminal device 102 may receive one or more responses to voice commands sent by a user in this state. These responses may be received in the form of data through data formatter 314. Once received, this data may be displayed to a user through user interface 308 and/or stored in database 132. Alternatively, these responses may be received in the form of voice signals through voice formatter 304, audio front end 306, and a speaker in user interface 308.

Terminal device 102 operations leave authenticated state 606 and return to idle state 602 upon the occurrence of event 614. This event occurs when the session established upon entry into connected state 604 is terminated.

FIG. 7 is a state diagram illustrating various operational states of task processor 106. As shown in FIG. 7, task processor 106 may operate in an idle state 702, a connected state 704, and an authenticated state 706. Transition events 708, 710, 712, and 714 cause transitions between these states.

When task processor 106 is in idle state 702, there is no connection established with terminal device 102. However, in this state, task processor 106 may perform processing of commands that were received in previously established sessions with terminal device 102. Also, during idle state 702 operations, task processor 106 may generate and store responses to commands for transmission to terminal device 102 in a subsequent session.

Task processor 106 operation transitions from idle state 702 to connected state 704 upon an occurrence of transition event 708. Transition event 708 occurs when a user of terminal device 102 causes a connection to be established with task processor 106. A user establishes such a connection through interaction with user interface 308 of terminal device 102. This interaction may include dialing a telephone number, or entering input commands that establish a session with a packet switched network, such as data network 208.

In connected state 704, task processor 106 may receive authentication information from terminal device 102. This authentication information may be encoded voice information, or data in a digital format. Task processor 106 processes this information to verify that a user is authorized to send voice commands to task processor 106. Also, while in connected state 704, task processor 106 sends a response to terminal device 102 that indicates the user has either been authenticated or denied access.

Task processor 106 operations leave connected state 704 upon the occurrence of either event 710 or event 712. Event 710 occurs when the data connection, or session, between terminal device 102 and task processor 106 has been terminated. Event 710 causes task processor 106 operations to return to idle state 702. Event 712 occurs when a user has been authenticated and causes task processor 106 operations to proceed to authenticated state 706.

While operating in authenticated state 706, task processor 106 may receive and process voice commands sent from terminal device 102. Also, in state 706, task processor 106 sends acknowledgments to terminal device 102 for each command it receives through data connection 104.

In addition to sending acknowledgments, application 408 may send one or more responses to terminal device 102 while task processor 106 is operating in state 706. These responses are application specific and may include the transfer of voice and data in both directions between terminal device 102 and task processor 106. Some of these responses may be to commands received during a previous operational interval in authenticated state 706.

Task processor 106 operations leave authenticated state 706 and return to idle state 702 upon the occurrence of event 714. This event occurs when the session established upon entry into connected state 704 is terminated.

Across all operational states of task processor 106, application 408 may process multiple commands simultaneously. For example, application 408 may receive and process a status inquiry command that relates to a previously received command that application 408 has not finished processing. The order and timing of responses for simultaneous command execution is application specific and not limited to the examples described herein.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of remotely invoking processing tasks at a task processor through voice commands from a terminal device across a data connection, comprising the steps of:
(a) initiating a voice command session with the task processor across the data connection;
(b) receiving at the terminal device an acknowledgment from the task processor that a session is established;
(c) sending an application specific command to the task processor after the task processor has acknowledged the session;
(d) receiving at the terminal device a response to the application specific command; and
(e) repeating steps (c) through (d), as desired.

2. The method of claim 1, wherein said sending an application specific command step comprises the steps of:
activating a push to talk (PTT) button; and
speaking a voice command into a microphone while the PTT button is activated.

3. The method of claim 1, wherein the data connection comprises a wireless Code Division Multiple Access (CDMA) data link.

4. The method of claim 1, wherein the terminal device is a portable handset.

5. The method of claim 1, further comprising the step of:
(f) receiving at the terminal device an acknowledgment transmitted by task processor, wherein the acknowledgment indicates that the task processor is processing the application specific command sent in step (c).

6. The method of claim 1, wherein the response comprises data.

7. The method of claim 1, wherein the response comprises voice signals.

8. A system for remotely invoking processing tasks at a task processor through voice commands from a terminal device across a data connection, comprising:
means for initiating a voice command session with the task processor across the data connection;
means for receiving at the terminal device an acknowledgment from the task processor that a session is established;
means for sending an application specific command to the task processor after the task processor has acknowledged the session; and
means for receiving at the terminal device a response to the application specific command.

9. The system of claim 8, wherein said means for sending an application specific command step comprises:
a push to talk (PTT) button; and
means for receiving voice commands into a microphone while the PTT button is activated.

10. The system of claim 8, wherein the data connection comprises a wireless code division multiple access (CDMA) data circuit.

11. The system of claim 8, wherein the terminal device is a portable handset.

12. The system of claim 8, further comprising means for receiving at the terminal device an acknowledgment transmitted by task processor, wherein the acknowledgment indicates that the task processor is processing the application specific command sent by said sending means.

13. The system of claim 8, wherein the response comprises data.

14. The system of claim 8, wherein the response comprises voice signals.
